(19) United States
(12) Patent Application Publication
(10) Pub. No.: US 2007/0136400 A1
(43) Pub. Date: Jun. 14, 2007

(54) Method and apparatus for integrating user communities with documentation

(75) Inventors: Andrea L. Ames, Redwood City, CA (US); Jeffrey T. Levitt, San Francisco, CA (US)

Correspondence Address: EDELL, SHAPIRO, & FINNAN, LLC, 1901 RESEARCH BOULEVARD, SUITE 400, ROCKVILLE, MD, 20850, US

(73) Assignee: International Business Machines Corporation, Armonk, NY (US)

(21) Appl. No.: 11/299,797

(22) Filed: Dec. 13, 2005

(51) Int. Cl. G06F 17/30

(52) U.S. Cl. 707/205

(57) ABSTRACT

An embodiment of the present invention integrates virtual user communities (e.g., forums, example exchanges, etc.) with on-line support information or documentation pertaining to tasks (e.g., installation or use of a software product, use of a consumer product, etc.) a user is attempting to perform. The community is integrated with the support information and automatically provided to the user. Only information relevant to the user task is provided from the community. The user may further interact with the community through the task support interface.

### BACKGROUND OF THE INVENTION

1. Technical Field

The present invention embodiments pertain to providing support documentation to a user. In particular, embodiments of the present invention pertain to a system and method integrating support or other documentation with relevant information from related virtual user communities (e.g., forums, example exchanges, etc.) to assist a user in performing a particular task.

2. Discussion of Related Art

Currently, user forums are utilized to enable users to discuss common issues with respect to various topics or items. For example, user forums may be utilized over a network to facilitate discussions or raise common issues with respect to various products (e.g., consumer electronics, software products, etc.).

However, these on-line forums are archaic, especially with respect to product support. In particular, users may submit questions to the forum, and when a user with the proper knowledge encounters the question, an answer may be provided. Although the forum induces retrieval of an answer, there is no reason for the user with the correct answer to waste time searching the forum for the corresponding question. In addition, other users with the same problem are required to search through the forum to find a similar question in an attempt to ascertain the answer as a response to that question.

Accordingly, forums suffer from several disadvantages. In particular, forums generally provide no mechanism to search for desired responses. Further, since forums are not oriented toward the task a user is attempting to perform, the forums do not help users accomplish their goals. Although current solutions include categorization of different forums on one site, these solutions alleviate only a portion of the disadvantages.

### SUMMARY OF THE INVENTION

Accordingly, an embodiment of the present invention includes a system for integrating documentation with information from user communities. The system includes a processing system to retrieve and provide documentation pertaining to a topic specified by a user in response to a request from that user, where the processing system includes one or more modules to access at least one user community and retrieve community information associated with the retrieved documentation. Each user community includes at least one entry each including metadata indicating attributes of that entry, and the modules correlate the retrieved documentation with metadata of community entries to retrieve the associated community information. At least one community includes at least one of a forum and an example exchange, and the documentation includes support information for a product. The processing system further includes a module to provide a user interface displaying the retrieved documentation and the associated community information.

The metadata includes at least one of category and type for each entry, and the documentation includes at least one attribute in common with the metadata, where the modules retrieve the associated community information based on at least one common attribute between the retrieved documentation and the metadata of the community entries. Each user community is arranged in the form of a schema including at least one block each associated with a type of entry for that user community. The entry type includes at least one of a question, reply, comment and example. The processing system further includes another module to generate an entry for a user community in response to a submission from the user and place the entry within that user community. The module automatically determines metadata for the generated entry based on attributes of the retrieved documentation or based on a comparison of keywords between the generated entry and at least one of the retrieved documentation, a predetermined set of keywords and other community entries. Alternatively, the metadata for the generated entry is provided by the user. The embodiments further include a method, apparatus and a program product apparatus for integrating documentation with information from user communities as described above.

The above and still further features and advantages of the present invention embodiments will become apparent upon consideration of the following detailed description thereof, particularly when taken in conjunction with the accompanying drawings wherein like reference numerals in the various figures are utilized to designate like components.

### BRIEF DESCRIPTION OF THE DRAWINGS

FIG. 1 is a diagrammatic illustration of an exemplary system topology for integration of user communities with support or other documentation according to an embodiment of the present invention.

FIG. 2 is an exemplary schema for a forum including metadata to enable retrieval of forum information according to an embodiment of the present invention.

FIG. 3 is a schematic illustration of an exemplary graphical user screen integrating user communities with support information according to an embodiment of the present invention.

FIG. 4 is a procedural flow chart illustrating the manner in which user communities are integrated with support information according to an embodiment of the present invention.

FIG. 5 is a flow diagram illustrating the manner in which information from user communities is utilized by a user in conjunction with support information according to an embodiment of the present invention.

### DETAILED DESCRIPTION OF THE PREFERRED EMBODIMENTS

On-line user forums are generally implemented as “threads”, where a comment or question with respect to a particular topic is initially entered and replies to that comment (e.g., more questions, replies to the original question, more comments, etc.) are nested within the topic. New threads may be created within the forum, and sub-threads of original threads may similarly be infinitely nested. An exemplary thread pertaining to table creation may be as follows.

| How do I create a table? | | (Initial Question for a Topic) |
|---|---|---|
| | Re: How do I create a table? | (A Reply to the Question) |
| | Re: How do I create a table? | (Another Reply) |
| A new website that deals with | | (Initial Comment or New Thread) |
| installation | | |
| I found a better way to write this | | (Initial Comment or New Thread) |
| function | | |
| | Re: I found a better way to write | (Reply to Comment) |
| | this function | |

The present invention embodiments define virtual user communities (e.g., forums, example exchanges, etc.) in a manner that enables the background language behind the community to permit inclusion of metadata for each community entry. The metadata is utilized to arrange entries in the community, thereby enabling retrieval of information from the community relevant to a particular user task. The metadata further enables interlinking between community entries and relevant support documentation. The community entries may be accessed by various software applications, and may be sorted via the metadata based on user goals specified in an application.

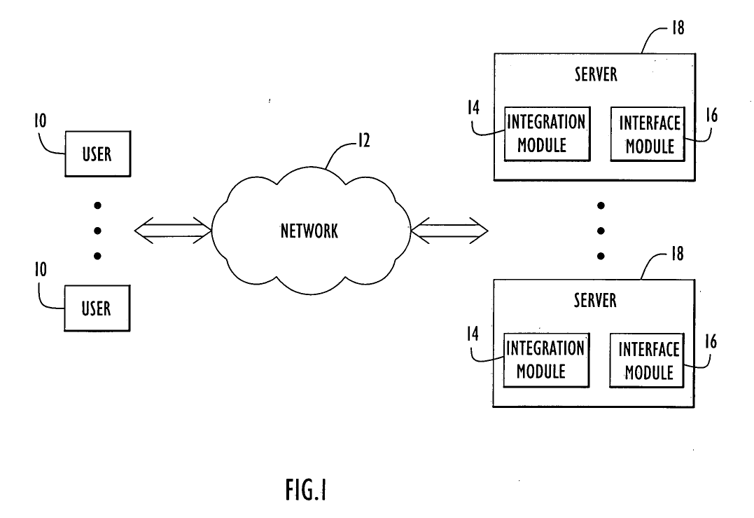

An exemplary system integrating user communities (e.g., forums, example exchanges, etc.) and support information according to an embodiment of the present invention is illustrated in FIG. 1. Specifically, the system includes one or more end-user systems 10, a network 12 and one or more server systems 18. The end-user and server systems may be implemented by any conventional or other computer systems preferably equipped with a display or monitor, a base (e.g., including the processor, memories and/or internal or external communications devices (e.g., modem, network cards, etc.)) and optional input devices (e.g., a keyboard, mouse or other input device).

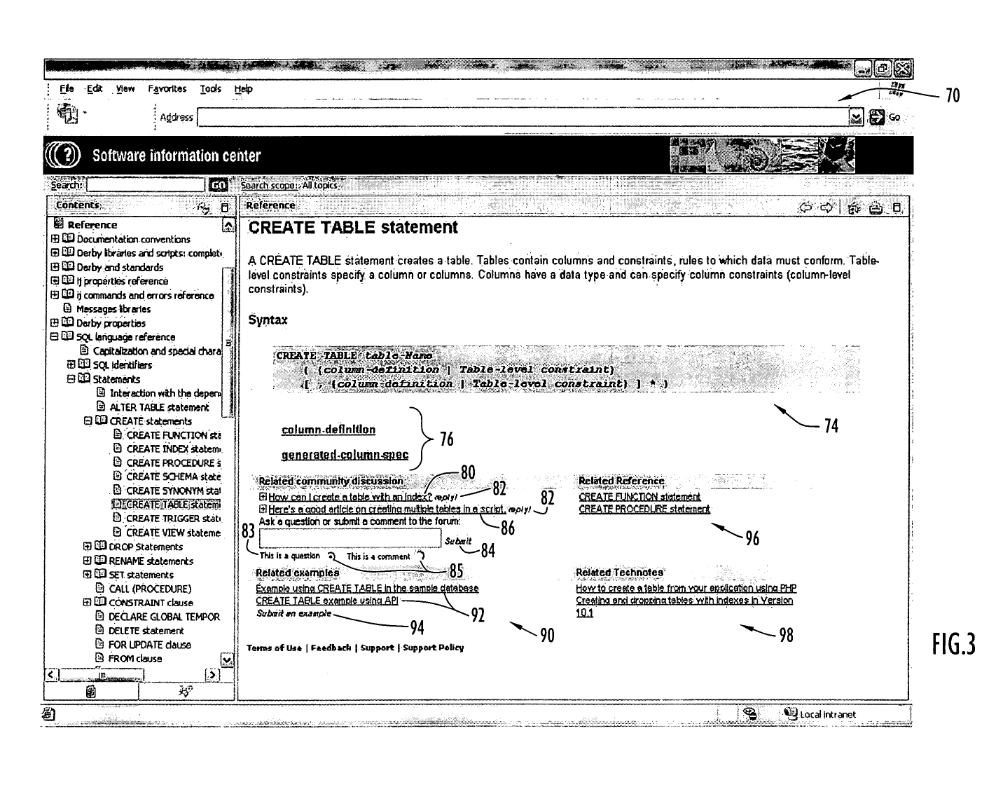

End-user systems 10 are coupled to server systems 18 via network 12. Network 12 may be implemented by any quantity of any suitable communications media (e.g., WAN, LAN, Internet, Intranet, etc.). The end-user systems may be local to or remote from the server systems. The server systems include an integration application or module 14 and an interface module 16. The interface module provides a user interface (e.g., FIG. 3) to enable a user to obtain relevant information (e.g., support information, etc.) as described below. Integration module 14 enables integration of one or more user communities (e.g., forums, example exchanges, etc.) with support or other information on the user interface for access by the user as described below. The integration and interface modules may be implemented by any combination of software and/or hardware modules or units. The integration module may be embedded within a software application providing documentation (e.g., product or other support information, etc.), and may be configured for any application or task to access community information. The server systems, under software control, basically implement the user community integration of an embodiment of the present invention. The software for the present invention embodiments (e.g., integration module, interface module, etc.) may be available on a recordable medium (e.g., magnetic, optical, floppy, DVD, CD, etc.) or in the form of a carrier wave or signal for downloading from a source via a communication medium (e.g., bulletin board, network, WAN, LAN, Intranet, Internet, etc.).

The user communities of the present invention embodiments are defined to include metadata. This may be accomplished by use of a specialized Extended Markup Language (XML) to define a community schema. For example, a forum XML specialization may include types and categories to classify the forum entries. The types and categories may be similar to an XML specialization for documentation (e.g., Darwin Information Typing Architecture (DITA), etc.). In this fashion, the forum entries may be categorized in a manner similar to the documentation to enable interlinking of relevant forum information to corresponding portions of the documentation. By way of example only, the forum entries and documentation may include categories of Installation, Development, Administration and Configuration. The forum entries may subsequently be sorted or arranged by those categories for data retrieval. In addition, the documentation and forum entries may be designated by various types (e.g., reference material, task material, conceptual information, etc.). However, any suitable categories and/or types may be utilized.

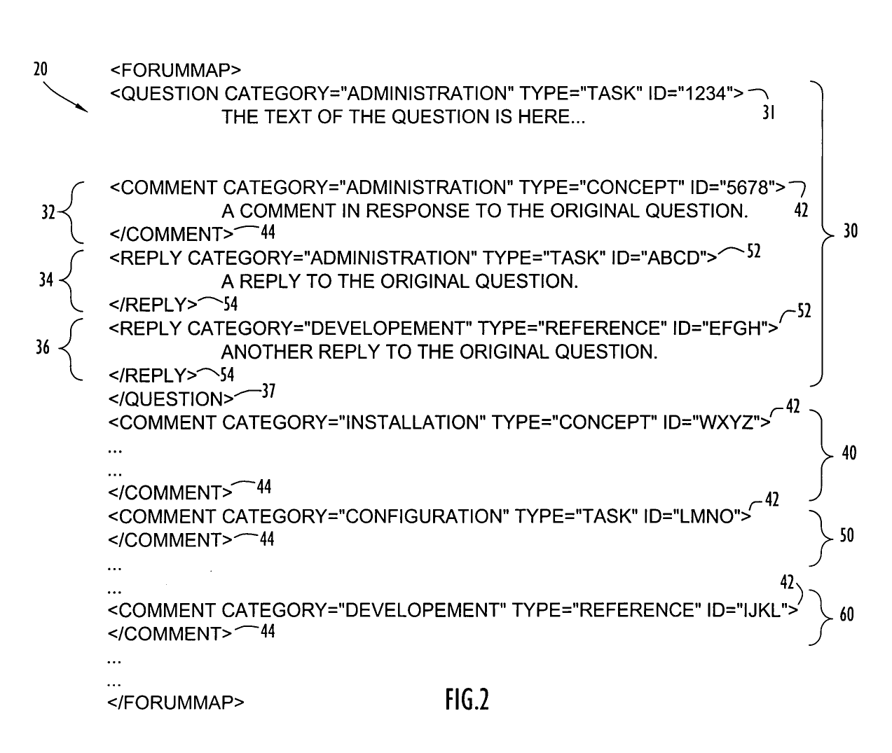

The XML specialization of the forum definition may employ these types and categories to sort or arrange the forum entries. The forum entries may be nested to indicate threads or topics as described above. An exemplary XML specialization of a forum definition or schema is illustrated in FIG. 2. Initially, entries in the forum are either questions, comments or replies, where a reply entry is only permitted as a response to a comment or question. Specifically, schema 20 includes a question block 30 and comment blocks 40, 50, 60. The schema may include any quantity of question and comment blocks each including an architecture as described below.

Question block 30 is delimited by a question block header 31 and a question block end indicator 37, and may include one or more comments, replies and/or further questions in response to the question. Question block header 31 includes metadata for searching and arranging forum entries. By way of example, the question block header includes a question category (e.g., “Administration”), a question type (e.g., “Task”) and an identification (e.g., “1234”). The text of the question is placed below header 31 within the question block.

Users may provide comments and/or replies to the question within the forum. Accordingly, question block 30 includes a comment block 32 to store user comments to the question. The architecture of the comment block is similar to the question block described above. In particular, comment block 32 is delimited by a comment block header 42 and a comment block end indicator 44. The comment block header includes metadata for searching and arranging the comment entry. By way of example, header 42 of comment block 32 includes a comment category (e.g., “Administration”), a comment type (e.g., “Concept”) and an identification (e.g., “5678”). The text of the comment is placed between header 42 and end indicator 44 within the comment block.

Question block 30 may further include reply blocks 34, 36 to store user replies to the question. The architecture of the reply block is similar to the comment block described above. In particular, reply block 34 is delimited by a reply block header 52 and a reply block end indicator 54. The reply block header includes metadata for searching and arranging the reply entry. By way of example, header 52 of comment block 34 includes a reply category (e.g., “Administration”), a reply type (e.g., “Task”) and an identification (e.g., “abcd”). The text of the reply is placed between header 52 and end indicator 54 within the reply block. Reply block 36 is substantially similar to reply block 34 described above and includes metadata indicating a reply category of “Development”, a reply type of “Reference” and an identification of “efgh” with the reply comment placed between header 52 and end indicator 54 of that reply block. Question block 30 may include any quantity of comment, reply or further question blocks to accommodate user comments, replies and/or further questions to the initial question.

Comment block 40 includes an architecture similar to that of comment block 32 described above. In particular, comment block 40 is delimited by comment block header 42 and comment block end indicator 44 as described above. The comment block header includes metadata for searching and arranging the comment entry. By way of example, header 42 of comment block 40 includes a comment category of “Installation”, a comment type of “Concept” and an identification of “wxyz”. The text of the comment is placed between header 42 and end indicator 44 within the comment block. Comment block 50 is substantially similar to comment block 40 described above and includes metadata indicating a comment category of “Configuration”, a comment type of “Task” and an identification of “lmno” with the comment placed between header 52 and end indicator 54 of that comment block. Comment block 60 is substantially similar to comment blocks 40, 50 described above and includes metadata indicating a comment category of “Development”, a comment type of “Reference” and an identification of “ijkl” with the comment placed between header 52 and end indicator 54 of that comment block. Comment blocks 40, 50, 60 may similarly include reply, comment and/or question blocks in a nested fashion as described above for question block 30 in order to accommodate comments, replies and/or further questions to the initial comment.

The metadata (e.g., category, type, etc.) of each forum entry (e.g., question, comment, reply, etc.) enables classification of the forum entries based on the information stored therein. The metadata is preferably provided by the server system (or integration module 14) based on the metadata of the initial question or comment, or based on the portion of documentation in which the user resides (e.g., topic, etc.) as described below. Thus, the system may automatically categorize user forum entries for subsequent search and retrieval. Alternatively, a user may provide the metadata for a forum entry. The system or integration module basically receives user entries (e.g., forum submissions with types, such as questions, comments, replies, etc.) and creates and/or inserts the entries in the proper location within schema 20 as described below. The schema may be subsequently accessed to retrieve desired data.

The forum entries may be identified and retrieved by integration module 14 based on the metadata and sorted or arranged in accordance with user specifications. The integration module may utilize an XLS Stylesheet and be implemented in the XPATH computing language; however, any suitable computing language may be utilized. For example, if a user needs assistance with installation of a product, the user may consult the forum to view replies and ascertain steps helpful to installing the product. In this case, the user is interested in viewing replies (without scrolling through questions) and “task” type forum entries that are categorized as “Installation” since these types of entries include the desired installation steps. An XSL Stylesheet may be utilized by integration module 14 (e.g., in the XPATH computing language) to retrieve the entries in the XML schema including a forum entry category of “Installation” and a type of “reply” for display in all documentation topics that also have a category of “Installation” and a type of “task” or “concept”. The users may subsequently re-sort and re-filter the retrieved information as described below.

The specialized forum schema enables individual forum entries to be categorized and provided with a type designation as described above. Further, the presentation of the entries into the forum may be customized, thereby enabling integration of useful forum information with relevant documentation. For example, once the user consults the documentation for answers to a question, the forum information is available for the specific topic. If the documentation does not provide sufficient answers, the user may submit questions or comments to a forum directly from the documentation as described below. The forum may further be integrated into a product, where forum information relevant to the user task (e.g., use or installation of the product, etc.) are dynamically updated and presented to the user during performance of that task. If the user requires additional information, the user may submit questions to the forum directly from the product interface.

By way of example, if the documentation is in a DITA format and displayed in an Eclipse-based information center, the documentation is organized into the same categories as the forum entries in the specialized forum XML schema described above. In this case, the information center may retrieve forum entries with categorizations similar to the displayed documentation for display (e.g., at the bottom of a particular documentation topic). For example, a “task” type topic categorized as “Installation” may be displayed with all forum entries including a category of “Installation” and type of “reply” or “comment” displayed at the bottom of the topic. This may be accomplished using RSS feeds (e.g., analagous to a subscription service to receive information) to the forum. The user consults the documentation to ascertain answers to questions, where relevant forum information is available with each topic. If the user requires additional information, the user may submit questions or comments to the forum directly from the information center using a form.

It is to be understood that present invention embodiments may include other user communities or types of information. For example, the present invention embodiments may include example exchanges, where information in the form of examples may be provided to a user. These examples may similarly be classified or categorized and provided with a type designation in substantially the same the manner described above to enable dynamic retrieval to the information center or other user interface. The examples may utilize a schema with example blocks, similar to the comment blocks described above, to include metadata. The documentation, forums and example exchanges preferably utilize common categories to enable the information to be linked via the metadata. However, since the documentation and each user community (e.g., forums, example exchanges, etc.) is different, the metadata designating the type is different for those items. By way of example, documentation types may include concept, reference and task, while forum entry types may include questions, comments and replies as described above. Example entry types may include sample, code snippet and demo.

Accordingly, the documentation and user communities may include different type designations to reflect the information form, but have common category designations or attributes to correlate communities with the documentation. The relationships between the metadata of each user community and the documentation may be designated in any suitable fashion. For example, documentation with a category of “Installation” and a type of “Task” may contain RSS feed subscriptions to forum entries with a category of “Installation” and a type of “Reply” and to all example exchange entries with a category of “Installation” regardless of the type.

The specialized content (e.g., topics, forum entries, examples, etc.) may alternatively be retrieved and inserted into a product interface. This may be accomplished with RSS feeds as described above. In this case, the user may be performing a task in a graphical user interface (GUI) of the product and a question may arise. Instead of searching an information center (e.g., by utilizing a web browser), forums and/or an example exchange, the user manipulates an input device (e.g., actuates a button, touches a key on the keyboard, etc.) and a pop-up window is displayed with the relevant documentation topic, relevant forum discussion, and relevant examples. These items are displayed in summary, dynamically updated, and hyperlinked for the user to obtain additional information. If the user requires additional information, the user may submit questions to the forum directly from the graphical user interface. In this fashion, the information and community help oriented around the user task is readily available.

An exemplary user interface integrating documentation with user communities (e.g., forums, example exchanges, etc.) according to an embodiment of the present invention is illustrated in FIG. 3. By way of example only, the user interface pertains to an information center providing support information for a database statement (e.g., create table). However, the present invention may include similar embodiments for any suitable application. The interface is displayed and handled by integration module 14 and interface module 16 (FIG. 1). Specifically, user interface 70 includes a content section 72, a reference section 74, a forum section 78 and an example section 90. The content section displays the content of information for the product arranged in a directory structure. The user may select desired content from this section. Reference section 74 displays support information for the desired content (e.g., create table statement) selected by the user from content section 72. The reference section includes links 76 to direct the user to additional information pertaining to the displayed information.

Forum section 78 includes relevant information retrieved from a forum organized in accordance with the schema described above (FIG. 2). By way of example, the forum section includes a question 80 and a comment 86. The appropriate items are retrieved from the forum based on the correlation of forum entry metadata with the selected content of the information center as described above. These items are in the form of links to initiate display of the associated items and are arranged in a directory structure to enable expansion for viewing of the thread. The question and comment are each associated with a reply link 82 enabling a user to enter replies to the question and comment. Further, the forum section includes a submission box 83 enabling a user to enter and submit a question or comment to the forum. A submit button 84 is disposed adjacent submission box 83 to initiate submission to the forum of the entered item, while radio buttons 85 indicate the item type (e.g., question or comment). In addition, the forum section includes links 96 to enable viewing of support information related to the selected content (e.g., create function and create procedure statements, etc.).

Example section 90 includes relevant information retrieved from an example exchange organized in accordance with the schema described above. By way of example, the example section includes examples 92 that are retrieved from the example exchange based on the correlation of example entry metadata with the selected content of the information center as described above. The examples are in the form of links to enable viewing of the associated example. Further, the example section includes a submit button 94 disposed below examples 92 to enable a user to submit an example to the example exchange. In addition, the example section includes links 98 to enable viewing of support information related to the selected content (e.g., technical notes, etc.).

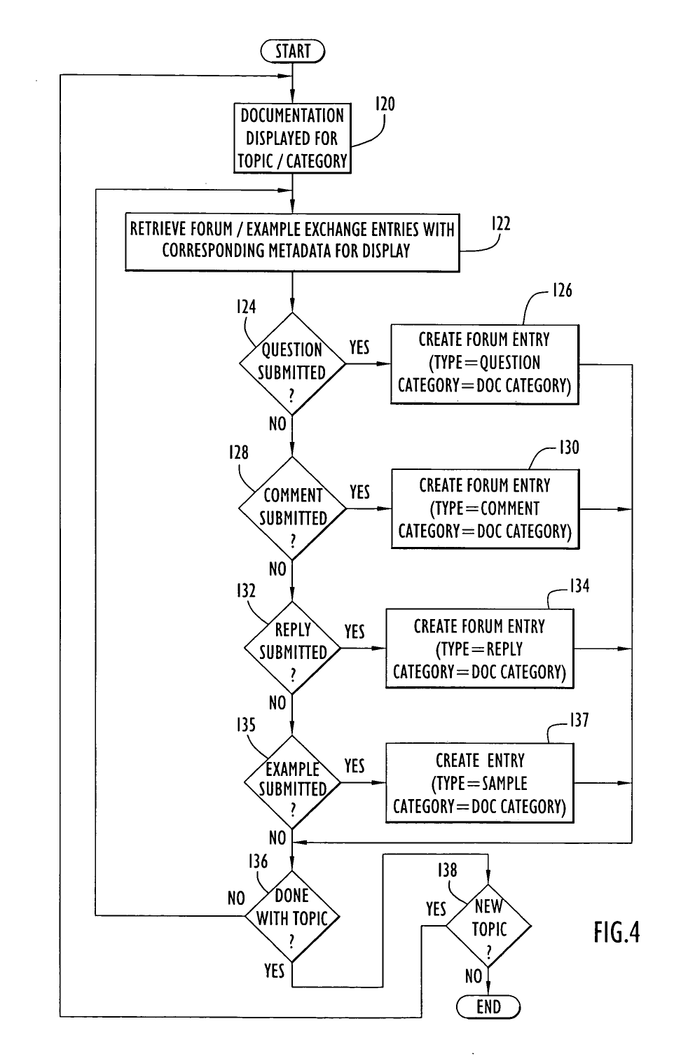

The manner in which the integration module integrates user communities (e.g., forums, example exchanges, etc.) with support or other documentation according to an embodiment of the present invention is illustrated, by way of example, in FIGS. 3-4. Initially, a user requests information for a desired topic from support or other documentation via content section 72 of user interface 70 as described above. Specifically, the corresponding documentation is retrieved at step 120 for display in reference section 74 of the user interface. The integration module retrieves entries from the forum and example exchanges at step 122 based on the relationships defined between the documentation category and entry metadata as described above. Corresponding forum entries are displayed in forum section 78, while corresponding examples are displayed in example section 90.

When the user submits a question as determined at step 124 via submission box 83 and submit button 84 as described above, a new forum entry is created at step 126 with a category matching the category of the documentation topic and a type of “Question”. If the user submits a comment as determined at step 128 via submission box 83 and submit button 84 as described above, a new forum entry is created at step 130 with a category matching the category of the documentation topic and a type of “Comment”. When the user submits a reply as determined at step 132 via reply link 82 as described above, a new forum entry is created at step 134 with a category matching the category of the documentation topic and a type of “Reply”. If the user submits an example as determined at step 135 via submit button 94 as described above, a new example exchange entry is created at step 137 with a category matching the category of the documentation topic and a type of the submitted example (e.g., “Sample”).

The integration of user communities with the documentation should be automated as much as possible. This includes performing automated categorization and/or type designation for forum or example entries. In this fashion, performance of categorization and type designation for entries obviates extra steps performed by a user. The automated process may automatically select and assign entry attributes based on the documentation type or category from which the items are created. Users may alter these attributes in the event the initially generated values are incorrect.

Alternatively, keywords or strings within the entry may be compared with an indexed set of keywords associated with types or categories, or the entry text may be compared to the documentation or other community content. In this case, valid attribute suggestions may be presented.

For example, a user may attempt to ascertain additional information pertaining to creating a table using SQL. When the user submits a question in the forum, keywords (e.g., “Creating”, “Table”, and “SQL”) are identified and compared with the documentation and the examples exchange. The user is supplied with the CREATE TABLE reference topic in the SQL documentation and any examples that use the CREATE TABLE syntax. The user is subsequently prompted to associate the forum entry with the two content items, and the next time a user of the documentation arrives at the CREATE TABLE topic, the replies to the forum discussion generated by the first user are displayed at the bottom of the topic.

Alternatively, a user may submit a new example for CREATE TABLE in the example exchange, and the new example is dynamically displayed in the reference topic for CREATE TABLE. In addition, a user may submit a question to the forum pertaining to deleting a row from a table. The user may further be provided with previous replies in the forum of type “Task” that contain the same keywords, thereby possibly answering the user question since another user may have encountered that problem.

If the user desires to remain within the current topic as determined at step 136, user community entries are retrieved for the documentation topic at step 122 to include any new entries. The process is further repeated for new submissions as described above. When a user decides to switch to a new topic as determined at steps 136, 138, corresponding documentation is displayed at step 120 and the process is repeated for the new topic in substantially the same manner described above. The above process may accommodate retrieval, submission and/or creation of entries for other user communities in substantially the same manner described above for the forum and example exchange.

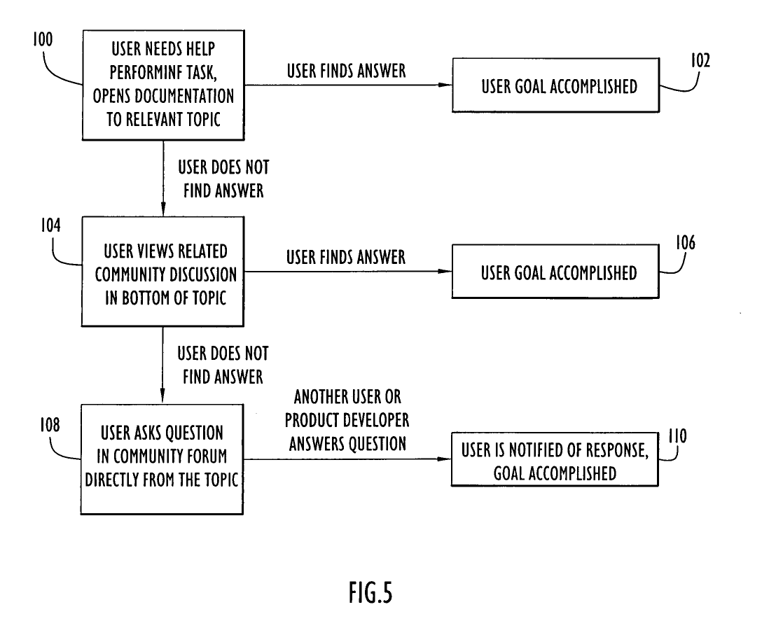

Operation of the present invention is described with reference to FIGS. 3 and 5. Initially, a user needs assistance performing a task and consults an appropriate topic within support or other documentation via user interface 70 at step 100. If the user ascertains appropriate information from content section 72 and/or reference section 74 to assist in performance of the task, the task may be accomplished at step 102.

When the user does not ascertain the information, the user may view related community discussions in forum section 78 and/or example section 90 at step 104. If the user ascertains appropriate information from forum section 78 and/or example section 90 to assist in performance of the task, the task may be accomplished at step 106.

When the user does not ascertain the information, the user may submit a question to the forum directly from the desired documentation topic at step 108 via submission box 83 and submit button 84 as described above. If another user or product developer answers the question, the forum section is updated and the user is notified of a response to accomplish the task at step 110. The user may alternatively submit comments, replies and/or examples, where the submitted items (e.g., questions, comments, replies, examples, etc.) and corresponding responses may be viewed by other users to assist those users with similar tasks.

It will be appreciated that the embodiments described above and illustrated in the drawings represent only a few of the many ways of implementing a method and apparatus for integrating user communities with documentation.

The environment of the present invention embodiments may include any quantity of end-user systems and server systems. The end-user and server systems employed by the present invention embodiments may be implemented by any quantity of any personal or other type of computer system (e.g., IBM-compatible, Apple, Macintosh, laptop, palm pilot, etc.), and may include any commercially available operating system (e.g., Windows, OS/2, Unix, Linux, etc.) and any commercially available or custom software (e.g., browser software, communications software, server software, interface and integration modules of the present invention embodiments, etc.). These systems may include any types of monitors and input devices (e.g., keyboard, mouse, voice recognition, etc.) to enter and/or view information.

It is to be understood that the software (e.g., integration and interface modules, etc.) and schemas for the computer systems of the present invention embodiments (e.g., server systems, etc.) may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the end-user and server systems. The software and/or algorithms described above and illustrated in the flow charts may be modified in any manner that accomplishes the functions described herein. In addition, the functions in the flow charts or description may be performed in any order that accomplishes a desired operation.

The software and schemas of the present invention embodiments may be available on a recordable medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

The communication network may be implemented by any quantity of any type of communications network (e.g., LAN, WAN, Internet, Intranet, VPN, etc.). The computer systems of the present invention embodiments (e.g., end-user systems, server systems, etc.) may include any conventional or other communications devices to communicate over the network via any conventional or other protocols. The computer systems (e.g., end-user system, server system, etc.) may utilize any type of connection (e.g., wired, wireless, etc.) for access to the network.

The schema may include any quantity of any types of information (e.g., comments, questions, replies, examples, etc.) arranged in any desired architecture (e.g., nested, hierarchical, blocks or units, etc.). The schema may be applied to any type of user community (e.g., forum, example exchange, etc.) or information type (e.g., documentation, technotes, etc.). The block headers and end indicator may include any desired characters or symbols and may include any desired information or attributes (e.g., category, type, identification, length, other metadata or information characteristics, etc.). The information or metadata may include any desired characteristics or attributes (e.g., categories, types, temporal indications, etc.) to identify relevant information. Each characteristic or attribute may have any quantity of any desired values. The user communities and documentation may employ any quantity of any common characteristics or attributes to define links or relationships between documentation and community information.

The characteristics or attributes for a community entry may be determined automatically by the system based on any desired criteria (e.g., based on the characteristics of the documentation, based on keyword comparisons, etc.), where the determined attributes may be modified by a user. Alternatively, the attributes may be entered by a user for community entries.

The integration and/or interface modules may be embedded within or invoked by any software module accessing user communities to integrate the community information with support or other information for any desired application.

The present invention embodiments may employ any quantity of user interface screens or other user interfaces, where the screens may include any information (e.g., documentation, user community, etc.) arranged in any fashion. The screens may include any quantity of any type of user communities displayed at any desired locations. The screens may display any quantity of entries for a community. The screens may include any quantity of any types of input or actuation mechanisms (e.g., buttons, icons, fields, boxes, links, etc.) disposed at any locations to enter/display information and initiate desired actions.

The present invention can take the form of an entirely hardware embodiment, an entirely software embodiment or an embodiment containing both hardware and software elements. In a preferred embodiment, the invention is implemented in software, which includes but is not limited to firmware, resident software, microcode, data structures, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It is to be understood that the present invention embodiments are not limited to the applications disclosed herein, but may be utilized for integrating any types of user communities (e.g., forums, example exchanges, etc.) with any types of information (e.g., support or other documentation, help information, product information, consumer information, etc.).

From the foregoing description, it will be appreciated that the invention makes available a novel method and apparatus for integrating user communities with documentation, wherein support or other documentation is integrated with relevant information from related virtual user communities (e.g., forums, example exchanges, etc.) to assist a user in performing a particular task.

Having described preferred embodiments of a new and improved method and apparatus for integrating user communities with documentation, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for integrating documentation with information from user communities comprising:
a processing system to retrieve and provide documentation pertaining to a topic specified by a user in response to a request from that user, said processing system including:
a community module to access at least one user community and retrieve community information associated with said retrieved documentation, wherein each said user community includes at least one entry each including metadata indicating attributes of that entry, and wherein said community module correlates said retrieved documentation with said metadata of community entries to retrieve said associated community information.

2. The system of claim 1, wherein said at least one community includes at least one of a forum and an example exchange.

3. The system of claim 1, wherein said documentation includes support information for a product.

4. The system of claim 1, wherein said processing system further includes:
an interface module to provide a user interface displaying said retrieved documentation and said associated community information.

5. The system of claim 1, wherein said metadata includes at least one of category and type for each said entry.

6. The system of claim 1, wherein said documentation includes at least one attribute in common with said metadata, and said community module retrieves said associated community information based on said at least one common attribute between said retrieved documentation and said metadata of said community entries.

7. The system of claim 1, wherein each user community is arranged in the form of a schema including at least one block each associated with a type of entry for that user community.

8. The system of claim 7, wherein said entry type includes at least one of a question, reply, comment and example.

9. The system of claim 1, wherein said processing system further includes:
an entry module to generate an entry for a user community in response to a submission from said user and place said entry within that user community.

10. The system of claim 9, wherein said entry module automatically determines said metadata for said generated entry.

11. The system of claim 10, wherein said entry module automatically determines said metadata based on attributes of said retrieved documentation.

12. The system of claim 10, wherein said entry module automatically determines said metadata based on a comparison of keywords between said generated entry and at least one of said retrieved documentation, a predetermined set of keywords and other community entries.

13. The system of claim 9, wherein said metadata for said generated entry is provided by said user.

14. A computer-implemented method of integrating documentation with information from user communities, wherein said documentation pertains to a topic specified by a user and is retrieved and provided in response to a request from that user, said method comprising:
accessing at least one user community and retrieving community information associated with said retrieved documentation, wherein each said user community includes at least one entry each including metadata indicating attributes of that entry, and wherein said associated community information is retrieved by correlating said retrieved documentation with said metadata of community entries.

15. The method of claim 14, wherein said at least one community includes at least one of a forum and an example exchange.

16. The method of claim 14, wherein said documentation includes support information for a product.

17. The method of claim 14 further including:
displaying a user interface with said retrieved documentation and said associated community information.

18. The method of claim 14, wherein said documentation includes at least one attribute in common with said metadata, and said associated community information is retrieved based on said at least one common attribute between said retrieved documentation and said metadata of said community entries.

19. The method of claim 14, wherein each user community is arranged in the form of a schema including at least one block each associated with a type of entry for that user community.

20. The method of claim 14 further including:
generating an entry for a user community in response to a submission from said user and placing said entry within that user community.

21. The method of claim 20, wherein said metadata is automatically determined for said generated entry.

22. The method of claim 21, wherein said metadata is determined based on attributes of said retrieved documentation.

23. The method of claim 21, wherein said metadata is determined based on a comparison of keywords between said generated entry and at least one of said retrieved documentation, a predetermined set of keywords and other community entries.

24. The method of claim 20, wherein said metadata for said generated entry is provided by said user.

25. A program product apparatus including a computer usable medium with computer program logic recorded thereon for integrating documentation with information from user communities, wherein documentation pertaining to a topic specified by a user is retrieved and provided in response to a request from that user, said program product apparatus comprising:
a community module to access at least one user community and retrieve community information associated with said retrieved documentation, wherein each said user community includes at least one entry each including metadata indicating attributes of that entry, and wherein said community module correlates said retrieved documentation with said metadata of community entries to retrieve said associated community information.

26. The apparatus of claim 25, wherein said at least one community includes at least one of a forum and an example exchange, and said documentation includes support information for a product.

27. The apparatus of claim 25 further including:
an interface module to provide a user interface displaying said retrieved documentation and said associated community information.

28. The apparatus of claim 25, wherein said documentation includes at least one attribute in common with said metadata, and said community module retrieves said associated community information based on said at least one common attribute between said retrieved documentation and said metadata of said community entries.

29. The apparatus of claim 25 further including:
an entry module to generate an entry for a user community in response to a submission from said user and place said entry within that user community.

30. The apparatus of claim 29, wherein said entry module automatically determines said metadata for said generated entry.

31. The apparatus of claim 30, wherein said entry module automatically determines said metadata based on attributes of said retrieved documentation.

32. The apparatus of claim 30, wherein said entry module automatically determines said metadata based on a comparison of keywords between said generated entry and at least one of said retrieved documentation, a predetermined set of keywords and other community entries.

33. The apparatus of claim 29, wherein said metadata for said generated entry is provided by said user.

34. An apparatus including a computer usable medium with a data structure recorded thereon for integrating documentation with information from user communities, wherein documentation pertaining to a topic specified by a user is retrieved and provided in response to a request from that user, said apparatus comprising:
at least one user community with each user community including:
at least one block each associated with a type of entry for that user community, wherein each block includes:
a header including metadata indicating attributes of the entry, wherein said retrieved documentation is correlated with said metadata to retrieve community information associated with said retrieved documentation;
a body including content of the entry; and
an end indicator indicating an end of the block.

35. The apparatus of claim 34, wherein said at least one community includes at least one of a forum and an example exchange.
